(19) United States
(12) Patent Application Publication
(10) Pub. No.: US 2010/0046103 A1
(43) Pub. Date: Feb. 25, 2010

(54) BRIGHTNESS ENHANCEMENT COMPONENT

(75) Inventors: Tou-Sheng YEH, TAOYUAN (TW); Horng-Chin YEH, TAOYUAN (TW)

Correspondence Address: BRIAN M. MCINNIS, 12th Floor, Ruttonjee House, 11 Duddell Street, Hong Kong, HK

(73) Assignee: ITEQ CORPORATION, TAOYUAN (TW)

(21) Appl. No.: 12/345,675

(22) Filed: Dec. 30, 2008

(30) Foreign Application Priority Data
Aug. 21, 2008 (TW) 97215038
Sep. 30, 2008 (TW) 97217558

(51) Int. Cl. G02B 5/04

(52) U.S. Cl. 359/831; 359/599

(57) ABSTRACT

A brightness enhancement component includes a substrate and a plurality of prism elements. The prism elements are serially disposed on the substrate. A V-shaped trough is formed between each immediately-adjacent two prism elements. All the V-shaped troughs have their bottom ends disposed within a reference plane. A first prism element group each has a relatively high crest higher than the reference plane by a first height. A second prism element group each has a relatively low crest higher than the reference plane by a second height, wherein each of the first prism element group and each of the second prism element group are alternately arranged on the substrate, the first height is larger than the second height.

### RELATED APPLICATIONS

This application claims priority to Taiwan Application Serial Number 97215038 filed Aug. 21, 2008 and 97217558 filed Sep. 30, 2008, which are both herein incorporated by reference.

### BACKGROUND

1. Field of Invention

The present invention relates generally to a brightness enhancement film, and more particularly, relates to the brightness enhancement film used in a backlit liquid crystal display.

2. Description of Related Art

A backlit liquid crystal display generally includes a brightness enhancement film, which is typically positioned between a diffuser and a liquid crystal display panel. The backlit liquid crystal display also includes a light source such as a fluorescent lamp, a light guide for transporting light for reflection toward the liquid crystal display panel, and white reflector for reflecting light toward the liquid crystal display panel. The brightness enhancement film collimates light emitted from the light guide thereby increasing the brightness of the liquid crystal display panel. The increased brightness enables a sharper image to be produced by the liquid crystal display panel and allows the power of the light source to be reduced to produce a selected brightness. The brightness enhancement film in the backlit liquid crystal display is useful in equipment such as computers, personal TVs, video recorders, mobile communication devices, and automobile and avionics instrument displays.

### SUMMARY

It is therefore an objective of the present invention to provide an improved brightness enhancement component.

In accordance with the foregoing and other objectives of the present invention, a brightness enhancement component includes a substrate and a plurality of prism elements. The prism elements are serially disposed on the substrate. A V-shaped trough is formed between each immediately-adjacent two prism elements. All the V-shaped troughs have their bottom ends disposed within a reference plane. A first prism element group each has a relatively high crest higher than the reference plane by a first height. A second prism element group each has a relatively low crest higher than the reference plane by a second height, wherein each of the first prism element group and each of the second prism element group are alternately arranged on the substrate, the second height ranges from about 85% to about 93% of the first height.

In accordance with the foregoing and other objectives of the present invention, a brightness enhancement component includes a first brightness enhancement film and a second brightness enhancement film. Each brightness enhancement film has a prism surface and a flat surface on two opposite sides, wherein the prism surface of the first brightness enhancement film is in contact with the flat surface of the second brightness enhancement film. A plurality of prism elements are serially disposed on the substrate. A V-shaped trough is formed between each immediately-adjacent two prism elements. All the V-shaped troughs have their bottom ends disposed within a reference plane. A first prism element group each has a relatively high crest higher than the reference plane by a first height. A second prism element group each has a relatively low crest higher than the reference plane by a second height, wherein each of the first prism element group and each of the second prism element group are alternately arranged, the second height ranges from about 85% to about 93% of the first height.

In accordance with the foregoing and other objectives of the present invention, a brightness enhancement component includes a substrate and a plurality of prism elements. The prism elements are serially disposed on the substrate. A V-shaped trough is formed between each immediately-adjacent two prism elements. All the V-shaped troughs have their bottom ends disposed within a reference plane. A first prism element group each has a relatively high crest higher than the reference plane by a first height. The relatively high crest has a first included angle with a first bisector, which is perpendicular to the reference plane. A second prism element group each has a relatively low crest higher than the reference plane by a second height. The relatively low crest has a second included angle with a second bisector, which is not perpendicular to the reference plane, wherein each of the first prism element group and each of the second prism element group are alternately arranged on the substrate, the first height is greater than the second height.

In accordance with the foregoing and other objectives of the present invention, a brightness enhancement component includes a first brightness enhancement film and a second brightness enhancement film. Each brightness enhancement film has a prism surface and a flat surface on two opposite sides, wherein the prism surface of the first brightness enhancement film is in contact with the flat surface of the second brightness enhancement film. A plurality of prism elements are serially disposed on the substrate A V-shaped trough is formed between each immediately-adjacent two prism elements. All the V-shaped troughs have their bottom ends disposed within a reference plane. A first prism element group each has a relatively high crest higher than the reference plane by a first height. The relatively high crest has a first included angle with a first bisector, which is perpendicular to the reference plane. A second prism element group each has a relatively low crest higher than the reference plane by a second height. The relatively low crest has a second included angle with a second bisector, which is not perpendicular to the reference plane, wherein each of the first prism element group and each of the second prism element group are alternately arranged on the substrate, the first height is greater than the second height.

Thus, the present invention provides a new brightness enhancement component to be stacked to reduce moiré effect, to enhance display performance, and to reduce contact area between two brightness enhancement components so as to enhance anti-static charge performance.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a brightness enhancement component according to first preferred embodiment of this invention;

FIG. 2 and FIG. 3 respectively illustrate two cross-sectional views of the brightness enhancement component as illustrated in FIG. 1;

FIG. 4 illustrates a brightness enhancement component according to a second preferred embodiment of this invention;

FIG. 5 illustrates a brightness enhancement component according to a third preferred embodiment of this invention;

FIG. 6 illustrates a brightness enhancement component according to fourth preferred embodiment of this invention;

FIG. 7 and FIG. 8 respectively illustrate two cross-sectional views of the brightness enhancement component as illustrated in FIG. 6;

FIG. 9 illustrates a brightness enhancement component according to a fifth preferred embodiment of this invention; and

FIG. 10 illustrates a brightness enhancement component according to a sixth preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

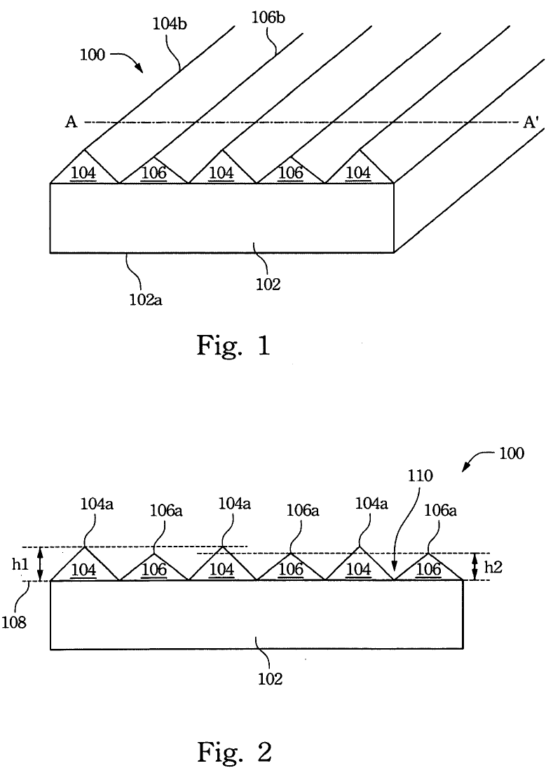

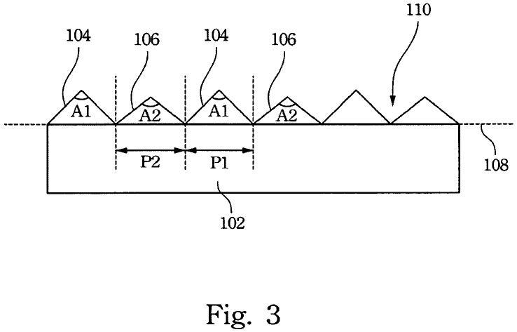

FIG. 1 illustrates a brightness enhancement component according to first preferred embodiment of this invention. FIG. 2 and FIG. 3 respectively illustrate two cross-sectional views of the brightness enhancement component taken along A-A′ as illustrated in FIG. 1. The brightness enhancement component 100 includes a substrate 102 and a plurality of prism elements (104, 106) arranged on the substrate 102. Those prism elements (104, 106) are divided into two groups: a first prism element group 104 and a second prism element group 106. Each prism of the first prism element group 104 has a relatively high crest 104a while each prism of the second prism element group 106 has a relatively low crest 106a. Each prism of the first prism element group 104 and each prism of the second prism element group 106 are alternately arranged on the substrate 102. That is, each prism of the first prism element group 104 is arranged between two prisms of the second prism element group 106. Or each prism of the second prism element group 106 is arranged between two prisms of the first prism element group 104. The relatively high crest 104a is higher than a reference plane 108 by a height (h₁) while the relatively low crest 106a is higher than the reference plane 108 by a height (h₂). In this embodiment, the reference plane 108 is a virtual plane within which all the V-shaped troughs 110 having their bottom ends disposed. The V-shaped trough 110 is formed between each immediately-adjacent two prism elements (104, 106).

In order to overcome conventional disadvantages of overlapped multiple brightness enhancement films, e.g. moiré patterns and particles attracted by static charges between brightness enhancement films, h₂/h₁ ratio preferably ranges from about 85% to about 93%. The experiment results show that anti-static charge performance is not effectively enhanced when a difference between h₂ and h₁ is less than 7% of h₁. When the difference between h₂ and h₁ is more than 20% of h₁, anti-moiré effect is enhanced, but the brightness enhancement performance is lowered. When multiple brightness enhancement films 100 are stacked, one brightness enhancement film has its prism surface in contact with a flat bottom surface (i.e. bottom surface 102a) of another brightness enhancement film. Because only the relatively high crests 104a are in contact with the flat bottom surface of another brightness enhancement film and the relatively low crest 106a are not contact with the flat bottom surface of another brightness enhancement film, contact areas between two brightness enhancement films are reduced and anti-static charge performance is thus enhanced.

In one embodiment, the difference between h₂ and h₁ ranges from 2 microns to about 10 microns. In another embodiment, the difference between h₂ and h₁ ranges from 3 microns to about 5 microns.

Referring to FIG. 3, the first prism element group 104 has a prism width P₁, which is substantially equal to a prism width P₂ of the second prism element group 106. In one embodiment, the prism width (P₁ or P₂) ranges from about 45 microns to about 55 microns. In another embodiment, the prism width (P₁ or P₂) ranges from about 35 microns to about 45 microns.

In one embodiment, the relatively low crest 106a has an included angle (A₂) greater than an included angle (A₁) of the relatively high crest 104a. In another embodiment, the included angle (A₁) ranges from about 85 degrees to about 100 degrees. In still another embodiment, the included angle (A₁) is about 90 degrees.

Referring to FIG. 1, all the relatively high crests 104a and the relatively low crests 106a have their crest lines (104b, 106b) in parallel with one another.

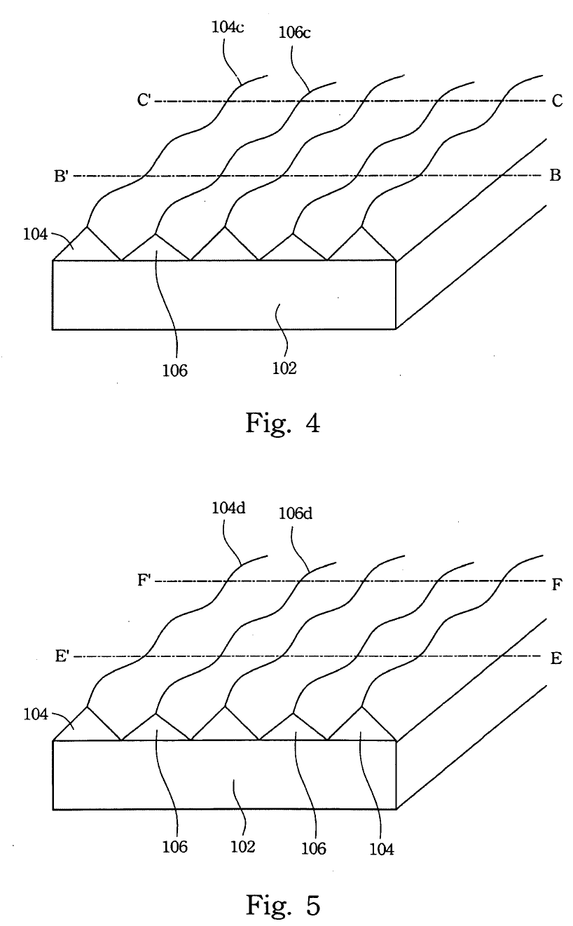

FIG. 4 illustrates a brightness enhancement component according to a second preferred embodiment of this invention. The difference between this embodiment and FIG. 1's embodiment lies in crest line. In particular, the crest lines 104c are wavy (from top view) within a first plane that is in parallel with the reference plane 108 while the crest lines 106c are wavy (from top view) within a second plane that is in parallel with the reference plane 108. In addition, all the relatively high crests and the relatively low crests have their crest lines (104c, 106c) in parallel with one another. The first plane of height (h₁) is higher than the second plane of height (h₂). Any cross-sectional view (such as views taken along B-B′ or C-C′) has its h₂/h₁, P₂/P₁ and A₂/A₁ ratio same as the embodiments illustrated in FIG. 2 and FIG. 3.

FIG. 5 illustrates a brightness enhancement component according to a second preferred embodiment of this invention. The difference between this embodiment and FIG. 4's embodiment lies in crest line. In particular, the crest lines 104d are wavy (from side view) within a plane that is perpendicular to the reference plane 108 while the crest lines 106d are wavy (from side view) within a plane that is perpendicular to the reference plane 108. In addition, all the relatively high crests and the relatively low crests have their crest lines (104d, 106d) in parallel with one another. Any cross-sectional view (such as views taken along D-D′ or E-E′) has its h₂/h₁, P₂/P₁ and A₂/A₁ ratio same as the embodiments illustrated in FIG. 2 and FIG. 3.

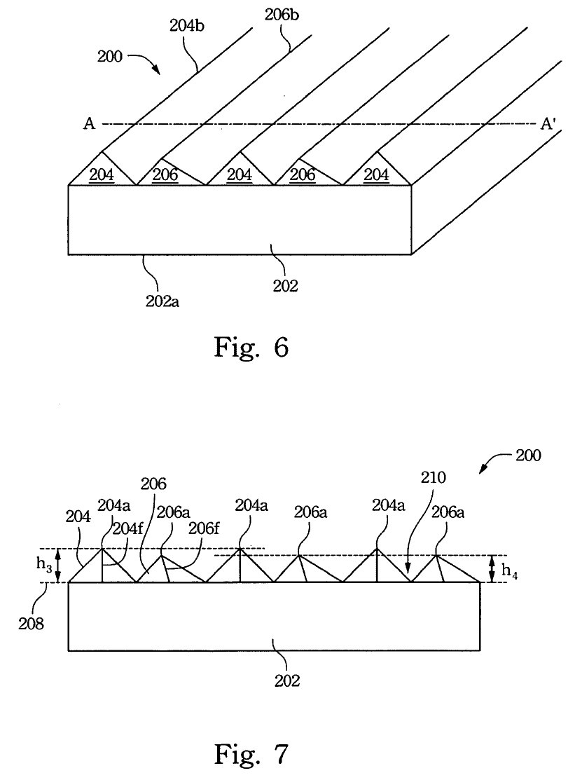

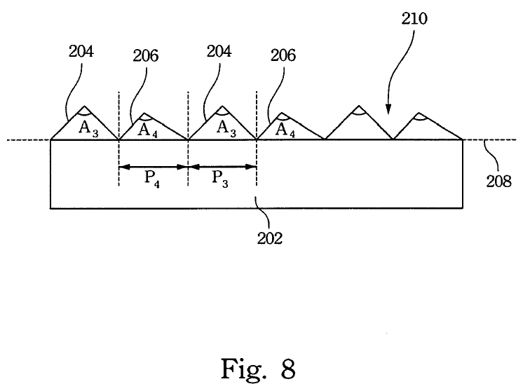

FIG. 6 illustrates a brightness enhancement component according to fourth preferred embodiment of this invention. FIG. 7 and FIG. 8 respectively illustrate two cross-sectional views of the brightness enhancement component taken along A-A′ as illustrated in FIG. 6. The brightness enhancement component 200 includes a substrate 202 and a plurality of prism elements (204, 206) arranged on the substrate 202. Those prism elements (204, 206) are divided into two groups: a first prism element group 204 and a second prism element group 206. Each prism of the first prism element group 204 has a relatively high crest 204a while each prism of the second prism element group 206 has a relatively low crest 206a. Each prism of the first prism element group 204 and each prism of the second prism element group 206 are alternately arranged on the substrate 202. That is, each prism of the first prism element group 204 is arranged between two prisms of the second prism element group 206. Or each prism of the second prism element group 206 is arranged between two prisms of the first prism element group 204. The relatively high crest 204a is higher than a reference plane 208 by a height (h₃) while the relatively low crest 206a is higher than the reference plane 208 by a height (h₄). In this embodiment, the reference plane 208 is a virtual plane within which all the V-shaped troughs 210 having their bottom ends disposed. The V-shaped trough 210 is formed between each immediately-adjacent two prism elements (204, 206).

In order to overcome conventional disadvantages of overlapped multiple brightness enhancement films, e.g. moiré patterns and particles attracted by static charges between brightness enhancement films, h₃ should be greater than h₄. When multiple brightness enhancement films 200 are stacked, one brightness enhancement film has its prism surface in contact with a flat bottom surface (e.g. bottom surface 202a) of another brightness enhancement film. Because only the relatively high crests 204a are in contact with the flat bottom surface, i.e. bottom surface 202a, of another brightness enhancement film and the relatively low crest 206a are not contact with the flat bottom surface of another brightness enhancement film, contact areas between two brightness enhancement films is reduced and anti-static charge performance is thus enhanced.

In one embodiment with a prism width P₃=43 microns and a prism width P₄=36, the difference between h₄ and h₃ ranges from 1 microns to about 9 microns. In another embodiment with a prism width P₃=43 microns and a to prism width P₄=36, the difference between h₄ and h₃ ranges from 2 microns to about 5 microns.

Referring to FIG. 7, the relatively high crest 204a has an included angle with a bisector 204f, which is perpendicular to a reference plane 208. The relatively low crest 206a has an included angle with a bisector 206f, which is not perpendicular to the reference plane 208. In another embodiment, the bisector 206f intersects the reference plane 208 to form an included angle ranging from about 80 degrees to about 100 degrees.

Referring to FIG. 8, the first prism element group 204 has a prism width P₃, which is larger than a prism width P₄ of the second prism element group 206. In one embodiment, the prism width P₄ is from about 80% to about 90% of the prism width P₃.

In one embodiment, an included angle (A₃) of the relatively high crest 204a is substantially a right angle (90±5 degrees) while an included angle (A₄) of the relatively low crest 206a is substantially another right angle (90±5 degrees).

Referring to FIG. 6, all the relatively high crests 204a and the relatively low crests 206a have their crest lines (204b, 206b) in parallel with one another.

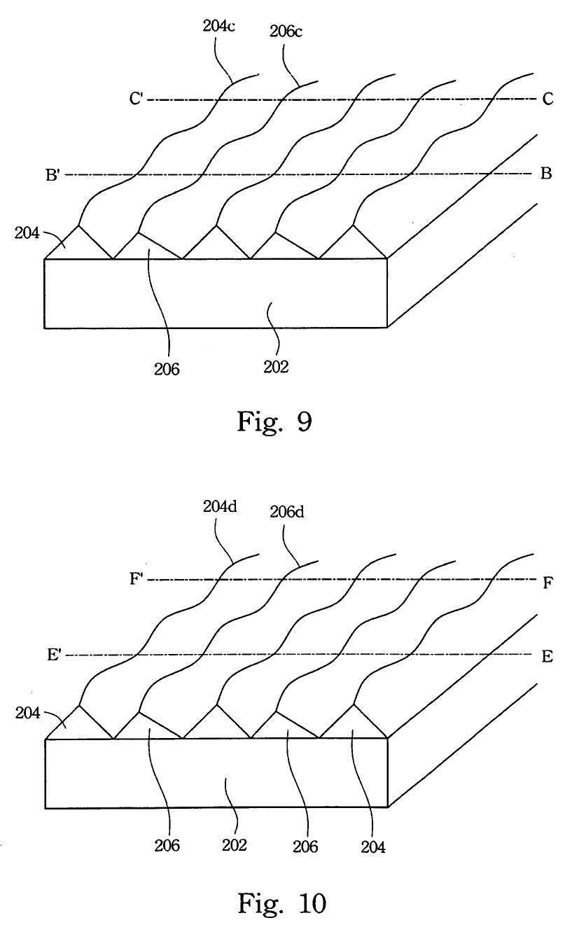

FIG. 9 illustrates a brightness enhancement component according to a fifth preferred embodiment of this invention. The difference between this embodiment and FIG. 6's embodiment lies in crest line. In particular, the crest lines 204c are wavy (from top view) within a first plane that is in parallel with the reference plane 208 while the crest lines 206c are wavy (from top view) within a second plane that is in parallel with the reference plane 208. In addition, all the relatively high crests and the relatively low crests have their crest lines (204c, 206c) in parallel with one another. The first plane of height (h₃) is higher than the second plane of height (h₄). Any cross-sectional view (such as views taken along B-B′ or C-C′) has its h₄/h₃, P₄/P₃ and A₄/A₃ ratio same as the embodiments illustrated in FIG. 7 and FIG. 8.

FIG. 10 illustrates a brightness enhancement component according to a sixth preferred embodiment of this invention. The difference between this embodiment and FIG. 9's embodiment lies in crest line. In particular, the crest lines 204d are wavy (from side view) within a plane that is perpendicular to the reference plane 208 while the crest lines 206d are wavy (from side view) within a plane that is perpendicular to the reference plane 208. In addition, all the relatively high crests and the relatively low crests have their crest lines (204d, 206d) in parallel with one another. Any cross-sectional view (such as views taken along D-D′ or E-E′) has its h₄/h₃, P₄/P₃ and A₄/A₃ ratio same as the embodiments illustrated in FIG. 7 and FIG. 8.

The terms “substantially” as used herein may be applied to modify any quantitative representation which could permissibly vary without resulting in a change in the basic function to which it is related.

According to discussed embodiments, the present invention provides a new brightness enhancement component to be stacked to reduce moiré effect, to enhance display performance, and to reduce contact area between two brightness enhancement components so as to enhance anti-static charge performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A brightness enhancement component comprising:
a substrate; and
a plurality of prism elements being serially disposed on the substrate, a V-shaped trough being formed between each immediately-adjacent two prism elements, all the V-shaped troughs having their bottom ends disposed within a reference plane, the prism elements comprising:
a first prism element group each having a relatively high crest higher than the reference plane by a first height; and
a second prism element group each having a relatively low crest higher than the reference plane by a second height, wherein each of the first prism element group and each of the second prism element group are alternately arranged on the substrate, the second height ranges from about 85% to about 93% of the first height.

2. The brightness enhancement component of claim 1, wherein all the prism elements comprise the same prism width.

3. The brightness enhancement component of claim 2, wherein the relatively high crest comprises a first included angle ranging from about 85 degrees to about 100 degrees.

4. The brightness enhancement component of claim 3, wherein the first included angle is about 90 degrees.

5. The brightness enhancement component of claim 4, wherein the relatively low crest comprises a second included angle greater than the first included angle.

6. The brightness enhancement component of claim 1, wherein all the relatively high crests and the relatively low crests have their crest lines in parallel with one another.

7. A brightness enhancement component comprising:
a first brightness enhancement film and a second brightness enhancement film each having a prism surface and a flat surface on two opposite sides, wherein the prism surface of the first brightness enhancement film is in contact with the flat surface of the second brightness enhancement film, the prism surface comprising:
a plurality of prism elements being serially arranged, a V-shaped trough being formed between each immediately-adjacent two prism elements, all the V-shaped troughs having their bottom ends disposed within a reference plane, the prism elements comprising:
a first prism element group each having a relatively high crest higher than the reference plane by a first height; and
a second prism element group each having a relatively low crest higher than the reference plane by a second height, wherein each of the first prism element group and each of the second prism element group are alternately arranged, the second height ranges from about 85% to about 93% of the first height.

8. The brightness enhancement component of claim 7, wherein all the prism elements comprise the same prism width.

9. The brightness enhancement component of claim 8, wherein the relatively high crest comprises a first included angle ranging from about 85 degrees to about 100 degrees.

10. The brightness enhancement component of claim 9, wherein the first included angle is about 90 degrees.

11. The brightness enhancement component of claim 10, wherein the relatively low crest comprises a second included angle greater than the first included angle.

12. A brightness enhancement component comprising:
a substrate; and
a plurality of prism elements being serially disposed on the substrate, a V-shaped trough being formed between each immediately-adjacent two prism elements, all the V-shaped troughs having their bottom ends disposed within a reference plane, the prism elements comprising:
a first prism element group each having a relatively high crest higher than the reference plane by a first height, the relatively high crest having a first included angle with a first bisector being perpendicular to the reference plane; and
a second prism element group each having a relatively low crest higher than the reference plane by a second height, the relatively low crest having a second included angle with a second bisector being not perpendicular to the reference plane, wherein each of the first prism element group and each of the second prism element group are alternately arranged on the substrate, the first height is greater than the second height.

13. The brightness enhancement component of claim 12, wherein the second bisector intersects the reference plane to form a third included angle ranging from about 80 degrees to about 100 degrees.

14. The brightness enhancement component of claim 12, wherein each of the first prism element group has a first prism width and each of the second prism element group has a second prism width, the second prism width is from about 80% to about 90% of the first prism width.

15. The brightness enhancement component of claim 12, wherein the first included angle and second included angle are both right angles.

16. The brightness enhancement component of claim 12, wherein all the relatively high crests and the relatively low crests have their crest lines in parallel with one another.

17. A brightness enhancement component comprising:
a first brightness enhancement film and a second brightness enhancement film each having a prism surface and a flat surface on two opposite sides, wherein the prism surface of the first brightness enhancement film is in contact with the flat surface of the second brightness enhancement film, the prism surface comprising:
a plurality of prism elements being serially arranged, a V-shaped trough being formed between each immediately-adjacent two prism elements, all the V-shaped troughs having their bottom ends disposed within a reference plane, the prism elements comprising:
a first prism element group each having a relatively high crest higher than the reference plane by a first height, the relatively high crest having a first included angle with a first bisector being perpendicular to the reference plane; and
a second prism element group each having a relatively low crest higher than the reference plane by a second height, the relatively low crest having a second included angle with a second bisector being not perpendicular to the reference plane, wherein each of the first prism element group and each of the second prism element group are alternately arranged on the substrate, the first height is greater than the second height.

18. The brightness enhancement component of claim 17, wherein the second bisector intersects the reference plane to form an third included angle ranging from about 80 degrees to about 100 degrees.

19. The brightness enhancement component of claim 17, wherein each of the first prism element group has a first prism width and each of the second prism element group has a second prism width, the second prism width is from about 80% to about 90% of the first prism width.

20. The brightness enhancement component of claim 17, wherein the first included angle and second included angle are both right angles.
